(19) United States
(12) Patent Application Publication
(10) Pub. No.: US 2004/0176608 A1
(43) Pub. Date: Sep. 9, 2004

(54) Novel transition-metal complexes and use thereof in transition-metal catalyzed reactions

(76) Inventors: Siegfried Blechert, Berlin (DE); Hideaki Wakamatsu, Sendai (JP)

Correspondence Address: Bayer Chemicals Corporation, Patent Department, 100 Bayer Road, Pittsburgh, PA, 15205-9741, US

(21) Appl. No.: 10/484,944

(22) PCT Filed: Jul. 18, 2002
(86) PCT No.: PCT/EP02/08009

(30) Foreign Application Priority Data
Jul. 31, 2001 (DE) 101 37 051.2

(51) Int. Cl. C07F 15/00

(52) U.S. Cl. 548/103

(57) ABSTRACT

The invention relates to novel transition metal complexes of the formula (I) and (II),

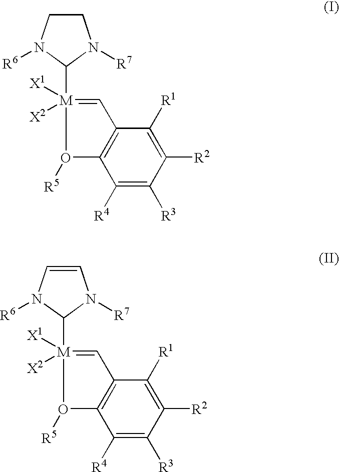

to processes for preparing these transition metal complexes, to intermediates for preparing them, and also to the use of the transition metal complexes as catalysts in organic reactions, particularly in metathesis reactions.

The invention relates to novel transition metal complexes of the formula (I) and (II), to processes for preparing these transition metal complexes, to intermediates for preparing them, and also to the use of the transition metal complexes as catalysts in organic reactions, particularly in metathesis reactions. Olefin metathesis constitutes an important synthetic method for C—C bond formation, since this reaction allows by-product-free olefins to be synthesized. This advantage is utilized not only in the field of preparative organic chemistry (ring-closing metathesis (RCM), ethenolysis, metathesis of acyclic olefins, cross-metathesis (CM)) but also in the field of polymer chemistry (ring-opening metathesis polymerizations (ROMP), alkyne polymerization, acyclic diene metathesis polymerization (ADMET)). For olefin metathesis, a multitude of catalyst systems is available. For instance, WO 99/51344 A1, WO 00/15339 A1 and WO 00/71554 A2 describe transition metal complexes which preferably bear ligands from the group of imidazol-2-ylidene, imidazol-2-ylidene and phosphine. The transition metal complexes mentioned are used as catalysts in olefin metathesis. A disadvantage of the catalysts described in the above-cited references is their low stability which manifests itself in very short catalyst onstream times, which are highly disadvantageous, especially for industrial applications. After a high starting activity, the catalyst activity falls rapidly. In addition, the catalyst activity of these catalysts is strongly substrate-dependent.

Gessler et al., Tetrahedron Lett. 41, 2000, 9973-9976 and Garber et al., J. Am. Chem. Soc. 122, 2000, 8168-8179 describe ruthenium complexes which, in addition to a dihydroimidazol-2-ylidene ligand, have an isopropoxybenzylidene ligand. The ruthenium complexes mentioned are used as catalysts in metathesis reactions, and can be removed from the reaction mixture and reused in a further metathesis reaction. A disadvantage of these reusable catalyst systems is their only moderate activities in comparison to the systems known hitherto.

There is therefore a need for novel catalyst systems for olefin metathesis which are stable and air-stable and, in addition, exhibit high activities.

Surprisingly, compounds of the formulae (I) and (II) have now been found

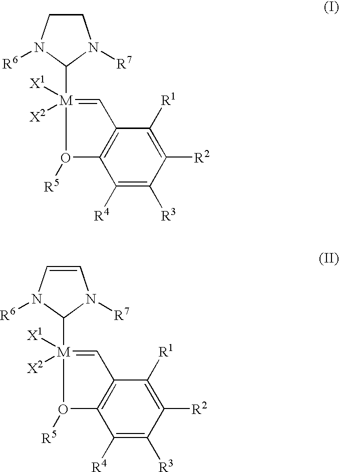

where

M is a transition metal of the 8th transition group of the Periodic Table,

X¹ and X² are the same or different and are each an anionic ligand,

R¹, R², R³ and R⁴ are the same or different and are each hydrogen, with the proviso that at least one radical R¹ to R⁴ is different to hydrogen, or are each cyclic, straight-chain or branched alkyl radicals having from 1 to 50 carbon atoms or aryl radicals having from 6 to 30 carbon atoms, where at least one hydrogen atom in the radicals mentioned is optionally replaced by an alkyl group or a functional group, and R¹ and/or R⁴ is also halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy, and/or

R¹ and R² or R² and R³ or R³ and R⁴ or R⁴ and R⁵ are part of a cyclic system which consists of a carbon framework having from 3 to 20 carbon atoms, not including the carbon atoms in formula (I), where at least one hydrogen atom is optionally replaced by an alkyl group or a functional group, and/or at least one carbon atom of the cycle is optionally being replaced by a heteroatom from the group of S, P, O and N, and

R⁵ is hydrogen or a cyclic, straight-chain or branched alkyl radical having from 1 to 20 carbon atoms or an aryl radical having from 6 to 20 carbon atoms, where at least one hydrogen atom in the radicals mentioned is optionally replaced by an alkyl group or a functional group, and

R⁶ and R⁷ are the same or different and are and are each cyclic, straight-chain or branched alkyl radicals having from 1 to 30 carbon atoms or are each aryl radicals having from 6 to 20 carbon atoms, where at least one hydrogen atom is optionally replaced by an alkyl group or a functional group.

The abovementioned functional groups are preferably radicals from the group of halogen, C₁-C₄-alkoxy, C₁-C₆-aryloxy, cyano, C₁-C₄-alkoxycarbonyl, C₁-C₆-aryloxycarbonyl and aliphatic or aromatic C₁-C₆-acyloxy.

Areas of preference of the radicals present in the above-cited formulae are defined hereinbelow:

M is preferably ruthenium or osmium.

X¹ and X² are the same or different and are preferably each an anionic ligand from the group of halides, pseudohalides, hydroxides, alkoxides, carboxylates and sulphonates, the pseudohalides preferably being cyanide, thiocyanate, cyanate, isocyanate and isothiocyanate.

R¹, R², R³ and R⁴ are the same or different and are preferably each hydrogen, with the proviso that at least one radical R¹ to R⁴ is different to hydrogen, or are each cyclic, straight-chain or branched alkyl radicals having from 1 to 20 carbon atoms or aryl radicals having from 6 to 20 carbon atoms, where at least one hydrogen atom in the alkyl and aryl radicals mentioned is optionally replaced by an alkyl group or a functional group, and R¹ and/or R⁴ is

halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy.

R¹, R² and R³ are preferably each hydrogen and R⁴ is a cyclic, straight-chain or branched alkyl radical having from 1 to 20 carbon atoms or an aryl radical having from 6 to 20 carbon atoms, where at least one hydrogen atom in the radicals mentioned is optionally replaced by an alkyl group or a functional group, or is halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy.

R¹ and R⁴ are the same or different and are preferably each hydrogen or an aryl radical having from 6 to 20 carbon atoms, where at least one hydrogen atom in the aryl radical is optionally replaced by an alkyl group or a functional group, or are each halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy and R² and R³ are part of a cyclic aromatic system having from 4 to 14 carbon atoms, not including the carbon atoms in formulae (I) and (II), where at least one hydrogen atom is optionally replaced by an alkyl group or a functional group.

R⁵ is preferably a straight-chain or branched alkyl radical having 1 to 20 carbon atoms.

R⁶ and R₇ are the same or different and are preferably each aryl radicals having from 6 to 14 carbon atoms, where at least one hydrogen atom is optionally replaced by an alkyl group or a functional group.

M is more preferably ruthenium.

X¹ and X² are the same and are more preferably each an anionic ligand from the group of halides and pseudohalides, the pseudohalides preferably being cyanide, thiocyanate, cyanate and isocyanate.

R¹, R², R³ and R⁴ are the same or different and are more preferably each hydrogen, with the proviso that at least one radical R¹ to R⁴ is different to hydrogen, or are each cyclic, straight-chain or branched alkyl radicals having from 1 to 10 carbon atoms or aryl radicals having from 6 to 14 carbon atoms, where at least one hydrogen atom in the alkyl or aryl radicals mentioned is optionally replaced by an alkyl group or a functional group, and R¹ and/or R⁴ is more preferably halogen, C₁-C₄-alkoxy, C₆-C₁₀-aryloxy, cyano, C₁-C₄-alkoxy-carbonyl, C₆-C₁₀-aryloxycarbonyl or aliphatic or aromatic C₁-C₁₀-acyloxy.

R¹, R² and R³ are more preferably each hydrogen and R⁴ is more preferably an aryl radical having from 6 to 14 carbon atoms, where at least one hydrogen atom in the aryl radical is optionally replaced by an alkyl group or a functional group, or is halogen, C₁-C₄-alkoxy, C₆-C₁₀-aryloxy, cyano, C₁-C₄-alkoxy-carbonyl, C₆-C₁₀-aryloxycarbonyl or aliphatic or aromatic C₁-C₁₀-acyloxy.

R¹ is more preferably hydrogen or halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy and R⁴ is hydrogen or an aryl radical having from 6 to 14 carbon atoms, where at least one hydrogen atom in the aryl radical is optionally replaced by an alkyl group or a functional group, or is halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy, and R² and R³ are part of a cyclic aromatic system having from 4 to 8 carbon atoms, not including the carbon atoms in formula (I) and (II), where at least one hydrogen atom is optionally replaced by an alkyl group or a functional group. R⁵ is more preferably a branched alkyl radical having from 3 to 8 carbon atoms.

R⁶ and R⁷ are more preferably identical aryl radicals having from 6 to 10 carbon atoms, where at least one hydrogen atom is preferably replaced by an alkyl group or a functional group.

M is most preferably ruthenium.

X¹ and X² are most preferably the same and are each a halide, preferably chloride.

R² and R³ are most preferably the same and are each hydrogen, and R¹ is hydrogen or is a radical from a group of Cl, Br, methoxy, ethoxy, isopropoxy, tert-butoxy, phenoxy, cyano, methoxycarbonyl, ethoxycarbonyl, tert-butoxycarbonyl, acetoxy, propionyloxy and pivaloyloxy, and R⁴ is phenyl or naphthyl, where at least one hydrogen may optionally be replaced by an alkyl group or functional group, preferably by C₁-C₄-alkyl or C₁-C₄-alkoxy, or is a radical from the group of Cl, Br, methoxy, ethoxy, isopropoxy, tert-butoxy, phenoxy, cyano, methoxycarbonyl, ethoxycarbonyl, tert-butoxycarbonyl, acetoxy, propionyloxy and pivaloyloxy.

R¹, R² and R³ are most preferably each hydrogen and R⁴ is most preferably a phenyl or naphthyl radical, where at least one hydrogen atom is optionally replaced by an alkyl group or a functional group, preferably by C₁-C₄-alkyl or C₁-C₄-alkoxy, or are each a radical from the group of Cl, Br, methoxy, ethoxy, isopropoxy, tert-butoxy, phenoxy, cyano, methoxycarbonyl, ethoxycarbonyl, tert-butoxycarbonyl, acetoxy, propionyloxy and pivaloyloxy.

R¹ is most preferably hydrogen or a radical from the group of Cl, Br, methoxy, ethoxy, isopropoxy, tert-butoxy, phenoxy, cyano, methoxycarbonyl, ethoxycarbonyl, tert-butoxycarbonyl, acetoxy, propionyloxy and pivaloyloxy, and R⁴ is most preferably hydrogen or phenyl or naphthyl, where at least one hydrogen is optionally replaced by an alkyl group or functional group, preferably by C₁-C₄-alkyl or C₁-C₄-alkoxy, or is a radical from the group of Cl, Br, methoxy, ethoxy, isopropoxy, tert-butoxy, phenoxy, cyano, methoxy-carbonyl, ethoxycarbonyl, tert-butoxycarbonyl, acetoxy, propionyloxy and pivaloyloxy, and R² and R³ are most preferably each part of a cyclic aromatic system having from 4 to 8 carbon atoms, not including the carbon atoms in formula (I) and (II), where at least one hydrogen atom is optionally replaced by an alkyl group or a functional group, preferably by C₁-C₄-alkyl or C₁-C₄-alkoxy.

R⁵ is most preferably a branched alkyl radical from the group of isopropyl, isobutyl, sec-butyl, tert-butyl, branched pentyl, branched hexyl.

R⁶ and R⁷ are most preferably each identical aryl radicals having from 6 to 10 carbon atoms, where at least one hydrogen atom is preferably replaced by an alkyl group from the group of methyl, ethyl, n-propyl, isopropyl, n-butyl, isobutyl, sec-butyl and tert-butyl.

Very particular preference is also given to the compounds of the formula (III) to (V)

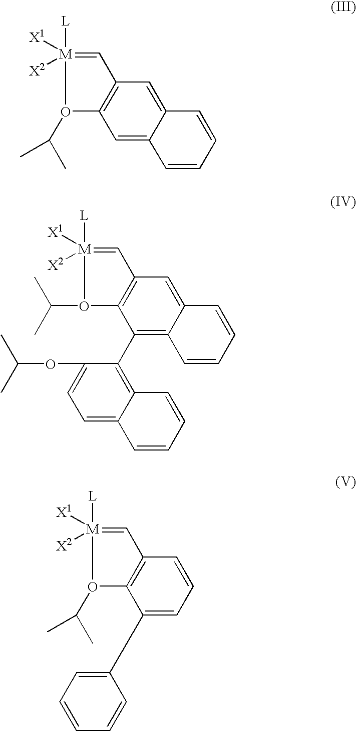

where

L is

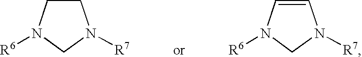

R⁶ and R⁷ are each mesityl,

X¹ and X² are each chloride and

M is ruthenium.

The above-cited radical definitions and illustrations cited in general or within areas of preference, i.e. the particular areas and areas of preference too, may be combined with each other as desired. They apply correspondingly to the end products and also to the precursors and intermediates.

In addition to air stability and tolerance toward functional groups, the compounds of the formula (I) and (U) according to the invention exhibit distinctly higher activities in metathesis reactions in comparison to the existing systems, for example the systems described in Tetrahedron Lett. 41, 2000, 9973-9976 and in J. Am. Chem. Soc. 122, 2000, 8168-8179, which is demonstrated in the present application with the aid of examples. The compounds of the formula (I) and (II) according to the invention are equally suitable for ring-closing metatheses, ring-opening metatheses, cross-metatheses and ring-opening metathesis polymerizations.

The compounds of the formula (I) and (II) according to the invention are preferably prepared by exchange reaction of the phosphine ligand PZ₃ in compounds of the formula (VI) by ligands of the formula (VII)

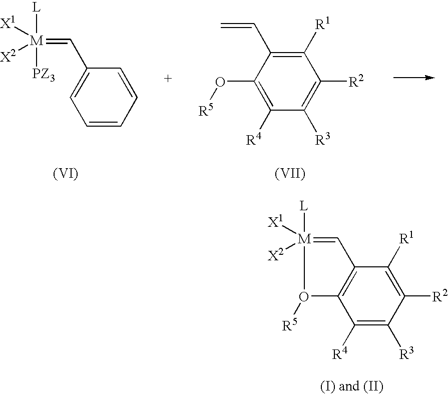

where

L is

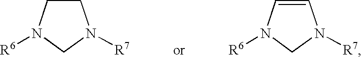

and R⁶ and R⁷ each have one of the above definitions and

M, R¹-R⁵, X¹ and X² each have one of the above definitions and

PZ₃ is a phosphine ligand, preferably tricyclohexylphosphine.

The compounds of the formula (I) and (II) according to the invention are preferably prepared from compounds of the formula (VI) in a solvent, more preferably in toluene, benzene, tetrahydrofuran or dichloromethane, most preferably in dichloromethane. The reaction preferably takes place in the presence of compounds which are capable of scavenging phosphines, more preferably in the presence of CuCl₂ and CuCl; most preferably in the presence of CuCl. Preference is given to working in the presence of equimolar amounts or of an excess of phosphine scavenger, based on compounds of the formula (VI). When CuCl is used as the phosphine scavenger, particular preference is given to using from 1 to 1.5 equivalents. Preference is given to using from 0.9 to 3 equivalents of the compounds of the formula (VII), based on compounds of the formula (VI), particular preference to from 1 to 2 equivalents. The reaction is preferably effected at temperatures of 20 to 80° C., more preferably at temperatures of 30 to 50° C. Preference is given to carrying out the reaction under inert gas, for example nitrogen or argon. The workup is preferably effected chromatographically, more preferably by column chromatography on silica gel.

Also in accordance with the invention are compounds of the formula (VII) which can be used as intermediates for preparing the compounds of formulae (I) and (II) according to the invention where the R¹-R⁵ radicals are each as defined above.

The compounds (VII) according to the invention are preferably prepared by converting compounds of the formula (XI) in a Wittig reaction, as described, for example, in Maryanoff et al., Chem. Rev. 89, 1989, 863-927. To obtain the compounds of the formula (XI), numerous routes are conceivable and disclosed in the literature. Preference is given to starting from phenols of the formula (VI) which are converted to compounds of the formula (X) using alkylating reagents of the formula (IX) where R⁵ is as defined above and Y is a leaving group, preferably a radical from the group of halogen, p-toluenesulfonyl and trifluoromethanesulfonyl (see scheme). These may subsequently be converted to the corresponding compounds of the formula (XI) by literature methods, as described, for example, in J. Chem. Soc., Perkin Trans. 2,1999, 1211-1218.

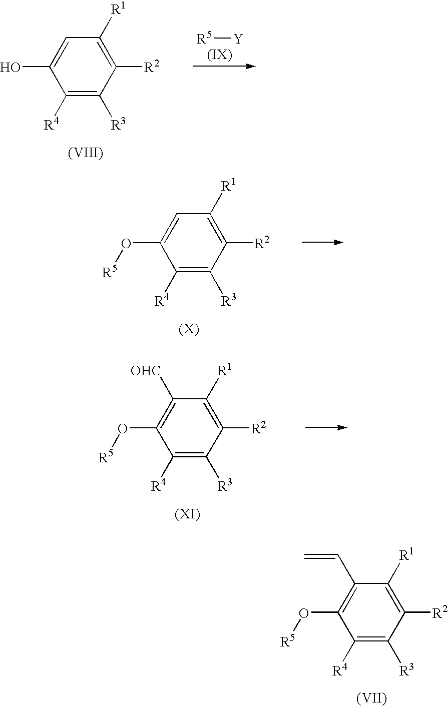

A variant which is likewise preferred for obtaining the compounds of the formula (XI) is the conversion of phenols of the formula (VII) to the corresponding o-aldehydes and the alkylation of these compounds to compounds of the formula (XI).

The compounds of the formula (VII) according to the invention may be used as ligands for preparing transition metal complexes, preferably for preparing transition metal complexes of the formula (I) and (II).

The compounds of the formula (I) and (II) according to the invention may be used as catalysts in chemical reactions, and preference is given to using them as catalysts in metathesis reactions. They may be used, for example, in ring-closing metatheses. Their very high activities are demonstrated with the aid of numerous examples of different substrates and also in comparison to existing systems. The ring-closing metatheses exhibit quantitative conversions even after only a few minutes. When used as ring-closing metathesis catalysts, the compounds of the formula (I) and (II) according to the invention lead, even at low temperatures (preferably between −10° C. and +20° C.) after a few hours virtually to quantitative yields, whereas catalysts known from the literature under comparable reaction conditions provide conversions of only ≦25% at distinctly longer reaction times.

When the compounds (I) and (II) according to the invention are used as catalysts in cross-metatheses, they likewise exhibit distinctly higher activities than catalyst systems known from the literature under comparable reaction conditions. The same observations were made in ring-opening metathesis polymerizations with subsequent cross-metathesis, which is demonstrated by the examples.

### EXAMPLES

### Example 1

### Synthesis of (R)-2,2′-diisopropoxy-3-vinyl-1,1′-binaphthyl

a) Synthesis of (R)-2,2′-diisopropoxy-1,1′-binaphthyl

2.0 g (6.98 mmol) of (R)-1,1′-binaphthyl-2,2′-diol were added to a suspension of 838 mg (20.95 mmol) of sodium hydride (60%) in 35 ml of dimethylformamide at 0° C. After stirring at room temperature for 1 h, 2.6 ml (27.94 mmol) of isopropyl bromide were added. This solution was stirred at room temperature for a further 86 h. After a saturated ammonium chloride solution had been added, the aqueous phase was extracted with methyl tert-butyl ether. The combined organic phases were washed with saturated sodium hydrogencarbonate solution and saturated sodium chloride solution, then dried over Na₂SO₄ and filtered, and the solvent was removed under reduced pressure. The residue was purified by column chromatography on silica gel (40:1 hexane/methyl tert-butyl ether). (R)-2,2′-Diisopropoxy-1,1′-binaphthyl was obtained in 80% yield.

¹H NMR (500 MHz, CDCl₃) δ 1.01 (d, J=6.1Hz, 6H), 109 (d, J=6.1Hz, 6H), 4.44 (qq, J=6.1, 6.1Hz, 2H), 7.19-7.21 (m, 4H), 7.33-7.36 (m, 2H), 7.44 (d, J=9.0 Hz, 2H), 7.88 (d, J=8.2Hz, 2H), 7.94 (d, 9.0Hz, 2H).

b) Synthesis of (R)-2,2′-diisopropoxy-1,1′-binaphthyl-3-carbaldehyde

4.7 ml (7.45 mmol) of n-butyllithium (1.6 M solution in hexane) were added dropwise at −78° C. to a solution of 1 ml (7.45 mmol) of tetramethylethylenediamine 6 ml of tetrahydrofuran. After 10 min, 920 mg (2.48 mmol) of (R)-2,2′-diisopropoxy-1,1′-binaphthyl in 6 ml of tetrahydrofuran were added. This reaction mixture was stirred at 0° C. for 1 h. After again cooling to −78° C., 1 ml (12.42 mmol) of dimethylformamide was added slowly, then the mixture was warmed to room temperature and stirred at room temperature for a further 1 h. After a saturatred ammonium chloride solution had been added, the aqueous phase was extracted with methyl tert-butyl ether. The combined organic phases were washed with saturated ammonium chloride solution and saturated sodium chloride solution, then dried over Na₂SO₄ and filtered, and the solvent was removed under reduced pressure. The residue was purified by column chromatography on silica gel (80:1-40:1 hexane/methyl tert-butyl ether). (R)-2,2′-Diisopropoxy-1,1′-binaphthyl-3-carbaldehyde was obtained in a 28% yield. 49% of the reactant used was recovered.

¹H-NMR (500 MHz, CDCl₃) δ 0.75 (d, J=6.2Hz, 3H), 0.93 (d, J=6.1Hz, 3H)), 1.01 (d, J=6.0Hz, 3H), 1.14 (d, J=6.0Hz, 3H), 3.89 (qq. J=6.1, 6.2Hz, 1H), 4.59 (qq, J=6.0, 6.0Hz, 1H), 7.17 (d, J=8.5Hz, 1H), 7.23 (d, J=8.5Hz, 1H), 7.25-7.28 (m 1H), 7.30-7.35 (m, 2H), 7.40-7.43 (m, 2H), 7.89 (d, J=8.1 Hz, 1H), 7.98-8.01 (m, 2H), 8.54 (s. 1H), 10.67 (s, 1H).

c) Synthesis of (R)-2,2′-diisopropoxy-3-vinyl-1,1′-binaphthyl

306 mg (2.73 mmol) of potassium tert-butoxide were added at 0° C. to a suspension of 974 mg (2.73 mmol) of Ph₃PCH₃Br in 9 ml of diethyl ether. The suspension was stirred at room temperature for a further 30 min. To this mixture were added at 0° C. 724 mg (1.82 mmol) of (R)-2,2′-diisopropoxy-1,1′-binaphthyl-3-carbaldehyde which were dissolved in three portions each of 3 ml diethyl ether. The resulting mixture was stirred at this temperature for a further 10 min. After the addition of the saturated ammonium chloride solution, the aqueous phase was extracted with methyl tert-butyl ether. The combined organic phases were washed with saturated ammonium chloride and saturated sodium chloride solution, then dried over Na₂SO₄ and filtered, and the solvent was removed under reduced pressure. The residue was purified by column chromatography on silica gel (40:1 hexane/methyl tert-butyl ether). (R)-2,2′-Diisopropoxy-3-vinyl-1,1′-binaphthyl was obtained in a 96% yield.

¹H NMR (500 MHz, CDCl₃) δ 0.80 (d, J=6.1Hz, 3H), 0.94 (d, J=6.1Hz, 3H), 1.07 (d, J=6.0Hz, 3H), 1.20 (d, J=6.0Hz, 3H), 3.94 (qq, J=6.1, 6.1Hz, 1 4.59 (qq, J=6.0, 6.0Hz, 1H), 5.44 (dd, J=1.0, 11.1Hz, 1H), 6.02 (dd, J=1.0, 17.7Hz, 1H), 7.21-7.29 (m, 4H), 7.33-7.42 (m, 3H), 7.45 (d, J9.3Hz, 1H), 7.89 (d, J=8.1Hz, 1H), 7.92 (d, J=8.2Hz, 1H), 7.99 (d, J=9.0Hz, 1H), 8.19 (s. 1H).

### Example 2

### Synthesis of a ruthenium compound having (R)-2,2′-diisopropoxy-3-vinyl-1,1′-binaphthyl as a ligand

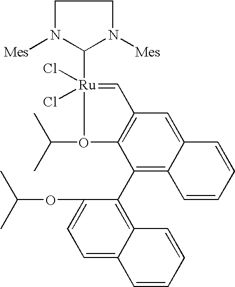

First 11 mg (0.11 mmol) of copper(I) chloride and then 88 mg (0.10 mmol) of tricyclohexylphosphine [1,3-bis(2,4,6-trimethylphenyl)-4,5-dihydroimidazole-2-ylidene][benzylidene]ruthenium(IV) dichloride dissolved in 2 ml of dichloromethane were added to a solution of 83 mg (0.21 mmol) of (R)-2,2′-diisopropoxy-3-vinyl-1,1′-binaphthyl in 8 ml dichloromethane. After stirring at 40° C. for 1 h, the reaction solution was concentrated under reduced pressure. The residue was taken up in very little dichloromethane and filtered through a Pasteur pipette with glass wool. The filtrate was concentrated again under reduced pressure and the residue was chromatography on silica gel (4:1 hexane/methyl tert-butyl ether). The desired compound was isolated in a 76% yield.

HR-MS m/z C₄₈H₅₂O₂N₂Cl₂ ¹⁰²Ru (M⁺) 860.2443, in some cases 860.2451.

### Example 3

### Synthesis of 2-isopropoxy-3-vinylbiphenyl

a) 2-Isopropoxybiphenyl

2 g (11.75 mmol) of biphenyl-2-ol were added at 0° C. to a suspension of 564 mg (14.1 mmol) of sodium hydride (60%) in 20 ml of dimethylformamide. After stirring at room temperature for 1 h, 1.7 ml (17.63 mmol) of isopropyl bromide were added. This solution was stirred at 50° C. for 53 h. After a saturated ammonium chloride had been added, the aqueous phase was extracted with methyl tert-butyl ether. The combined organic phases were washed with a 5% sodium hydroxide solution and saturated sodium chloride solution, then dried over Na₂SO₄ and filtered, and the solvent was removed under reduced pressure. The residue was purified by column chromatography on silica gel (20:1 hexane/methyl tert-butyl ether). 2-Isopropoxy-3-vinylbiphenyl was obtained in a 76% yield.

¹H NMR (500 MHz, CDCl₃) δ 1.26 (d, J=6.0Hz, 3H), 1.26 (d, J=6.0Hz, 3H), 4.45 (qq, J=6.0, 6.0Hz, 1H), 7.00-7.05 (m, 2H), 7.28-7.36 (m, 3H), 7.41 (dd, J=7.0, 7.3 Hz, 2H), 7.58 (d, J=7.8Hz, 2H).

b) 2-Isopropoxybiphenyl-3-carbaldehyde

### Preparation Variant A

16 ml (26.28 mmol) of n-butyllithium (1.6 M solution in hexane) were added dropwise at −78° C. to a solution of 3.9 ml (26.28 mmol) of tetramethylethylenediamine in 19 ml of tetrahydrofuran. After 10 min, 1.86 mg (8.76 mmol) of 2-isopropoxybiphenyl in 10 ml of tetrahydrofuran were added. This reaction mixture was stirred at 0° C. for a further 1 h. After cooling again to −78° C., 3.4 ml (43.81 mmol) of dimethylformamide were added slowly, then the mixture was warmed to room temperature and stirred at this temperature for a further 1.5 h. After a saturated ammonium chloride solution had been added, the aqueous phase was extracted with methyl tert-butyl ether. The combined organic phases were washed with saturated ammonium chloride solution and saturated sodium chloride solution, then dried over Na₂SO₄ and filtered, and the solvent was removed under reduced pressure. The residue was purified by column chromatography on silica gel (first hexane, then 40:1 hexane/methyl tert-butyl ether. 2-Isopropoxybiphenyl-3-carbaldehyde was obtained in a 16% yield. 76% of the reactant used was recovered.

### Preparation Variant B

141.7 mg (0.71 mmol) of 2-hydroxybiphenyl-3-carbaldehyde in 3 ml of dimethylformamide were added dropwise at 0° C. to 34 mg (0.86 mmol) of a suspension of sodium hydride (60%) in 4 ml of dimethylformamide. After stirring at room temperature for 30 min, 0.13 ml (1.43 mmol) of isopropyl bromide was added. This solution was stirred at 50° C. for 40 h. After water had been added, the aqueous phase was extracted using methyl tert-butyl ether. The combined organic phases were washed with saturated ammonium chloride solution and saturated sodium chloride solution, then dried over Na₂SO₄ and filtered, and the solvent was removed under reduced pressure. The residue was purified by column chromatography on silica gel (40:1 hexane/ethyl acetate). 2-Isopropoxybiphenyl-3-carbaldehyde was obtained in an 82% yield.

¹H-NMR (500 MHz, CDCl₃) δ 1.03 (d, J=6.1Hz, 6H), 3.81 (qq, J=6.1, 6.1Hz, 1 H), 7.25 (t, J=7.6Hz, 1H), 7.38 (t, J=7.3Hz, 1H), 7.45 (dd, J=7.3, 7.7Hz, 2H), 7.56-7.58 (m, 3H), 7.85 (dd, J=1.7, 7.6Hz, 1H), 10.52 (s. 1H).

c) 2-Isopropoxy-3-vinylbiphenyl

255 mg (2.27 mmol) of potassium tert-butoxide were added at 0° C. to a suspension of 812 mg (2.27 mmol) of Ph₃PCH₃Br in 6.5 ml of diethyl ether. The suspension was stirred at room temperature for a further 10 min. To this mixture were added at 0° C. 273 mg (1.14 mmol) of 2-isopropoxybiphenyl-3-carbaldehyde which were dissolved in three portions each of 1.5 ml diethyl ether. The resulting mixture was stirred at this temperature for a further 5 min. After the addition of a saturated ammonium chloride solution, the aqueous phase was extracted with methyl tert-butyl ether. The combined organic phases were washed with saturated ammonium chloride and saturated sodium chloride solution, then dried over Na₂SO₄ and filtered, and the solvent was removed under reduced pressure. The residue was purified by column chromatography on silica gel (80:1 hexane/methyl tert-butyl ether). 2-Isopropoxy-3-vinylbiphenyl was obtained in a 89% yield.

¹H-NMR (500 MHz, CDCl₃) δ 0.97 (d, J=6.1Hz, 6H), 3.75 (qq, J=6.1, 6.1Hz, 1 H), 5.30 (dd, J=0.9, 11.1Hz, 1H), 5.75 (dd, J=0,9, 17.8Hz, 1H), 7.14 (dd, J=7.4, 7.7Hz, 1H), 7.17 (dd, J=11.1, 17.8Hz, 1H), 7.26 (dd, J=1.4, 7.4Hz, 1H), 7.33 (t, J=7.3Hz, 1H), 7.41 (t, J=7.3Hz, 2H), 7.54 (dd, J=1.4, 7.7Hz, 1H), 7.57 (d, J=7,3 Hz, 2H).

### Example 4

### Synthesis of a ruthenium compound having 2-isopropoxy-3-vinylbiphenyl as a Ligand

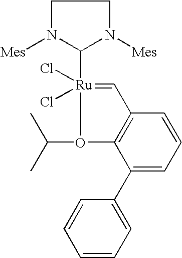

First 21 mg (0.22 mmol) of copper (I) chloride and then 168 mg (0.20 mmol) of tricyclohexylphosphine [1,3-bis(2,4,6-trimethylphenyl)-4,5-dihydroimidazole-2-ylidene][benzylidene]ruthenium(IV) dichloride dissolved in 4 ml of dichloromethane were added to a solution of 94 mg (0.39 mmol) of 2-isopropoxy-3-vinylbiphenyl in 16 ml dichloromethane. After stirring at 40° C. for 1 h, the reaction solution was concentrated under reduced pressure. The residue was taken up in very little dichloromethane and filtered through a Pasteur pipette with glass wool. The filtrate was concentrated again under reduced pressure and the residue was chromatographed on silica gel (4:1 hexane/methyl tert-butyl ether). The desired compound was isolated in a 71% yield.

HR-MS m/z C₃₇H₄₂ON₂Cl₂ ¹⁰²Ru (M⁺) 702.1711, in some cases 702.1719.

### Example 5

### RCM, Using the Compound from Example 2 as a Catalyst

A 0.01 M solution of the substrate (see table 1) in dichloromethane was admixed at room temperature with 1 mol % of the compound from example 2. After the specified reaction time, the metathesis product was removed by column chromatography on silica gel and the yield was determined.

In comparison, the conversion was determined by ¹H NMR when a catalyst of formula (A) was used (Weskamp et al., Angew. Chem., Int. Ed. Engl. 38, 1999, 2416-2419 and Scholl et al., Org. Lett. 6, 1999, 953-956)

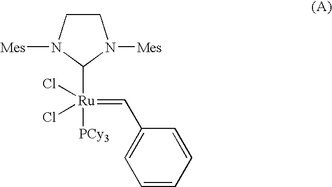

where Mes is mesitylene and PCy₃ is a tricyclohexylphosphine radical. On completion of conversion, metathesis product was removed by column chromatography on silica gel and the yield was determined (table 1)

TABLE 1

| | | | | Yield (%) | |
|---|---|---|---|---|---|
| | | | | Compound | |
| | | | Time | from | |
| Example | Substrate | Product | (min) | example 2^{a)} | (A)^{b)} |
| 1 | 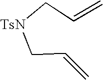 | 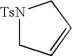 | 30 | quantitative | 70 (1 h, quantitative) |
| 2 | 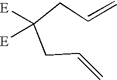 | 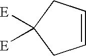 | 30 | 98 | 51 (1,5 h, quantitative) |
| 3 | 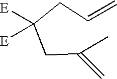 | 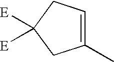 | 90 | quantitative | 69 (4 h, quantitative) |
| 4 | 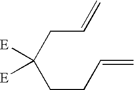 | 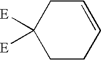 | 20 | quantitative | 40 (1,5 h, quantitative) |
| 5 | 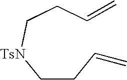 | 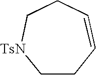 | 10 | quantitative | 18 (1 h, quantitative) |
| 6 | 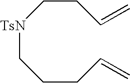 | 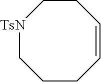 | 20 | quantitative | 4 (4 h, 93%) |

E = COOC₂H₅; Ts =

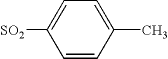

^{a)}Yield by isolation by means of chromatography on silica gel
^{b)}Conversion by ¹H NMR in brackets: complete conversion and yields by isolation by means of
chromatography on silica gel.

### Example 6

### RCM, Using the Compounds for Example 2 and 4 as Catalysts

A 0.01 M solution of N,N-bisallyltosylamide in dichloromethane was admixed at 0° C. with 1 mol % of the compound for example 4 or 1 mol % of the compound from example 2. The conversion was monitored by means of HPLC (reactant/product ratio). After the specified reaction time, the metathesis product was removed by column chromatography on silica gel and the yield was determined.

In a similar manner, the conversion and the yield were determined when 1 mol % of the catalyst of formula (A) was used.

TABLE 2

| | Conversion (%) | | |
|---|---|---|---|
| Time | | Compound from | Compound from |
| (min) | Catalyst (A) | example 2 | example 4 |
| 10 | 6.6 | 12.2 | 53.4 |
| 20 | 7.0 | 16.2 | 67.7 |
| 30 | 8.7 | 18.7 | 76.1 |
| 45 | — | — | 85.1 |
| 60 | 9.9 | 35.1 | 89.6 |
| 90 | 10.5 | 42.6 | 95.6 |
| 120 | 11.2 | — | — |
| 180 | 14.4 | — | — |
| 240 | 15.5 | 62.3 | — |
| 300 | 21.6 | 73.6 | — |
| 360 | 22.0 | 67.8 | — |

Yield with catalyst A after 4 days: 81%

Yield with compound from example 2 after 23 h: 89%

Yield with compound from example 4 after 1.5 h: 97%

### Example 7

### CM, Using the Compound from Example 2 as a Catalyst

O-Benzyl-4-penten-1-ol and two equivalents of methyl acrylate were initially charged as a 0.05 M solution in dichloromethane and admixed at room temperature with 1 mol % of the compound from example 2. After 20 min, the desired cross-metathesis product was isolated in a 95% yield. The reaction with 2-oxo-3-butene under the same reaction conditions likewise affords the desired cross-metathesis product in a 98% yield after 20 min.

### Example 8

### CM, Using the Compound from Example 4 as a Catalyst

O-Benzyl-4-penten-1-ol and two equivalents of methyl acrylate are initially charged as a 0.05 M solution in CH₂Cl₂ and admixed at room temperature with 1 mol % of the compound from example 2. After 15 min, the desired cross-metathesis product is isolated in a 93% yield.

### Example 9

### ROMP, Using the Compound from Example 4 as a Catalyst

A 0.15 molar solution of 1,5-cyclooctadiene in CD₂Cl₂ was admixed at 20° C. with 0.3 mol % of the compound from example 4. The conversion was monitored by ¹H NMR (reactant/product ratio).

In a similar manner, the conversion was determined when the catalyst of formula (A) was used.

TABLE 3

Conversion (%)

| | | Compound from |
|---|---|---|
| Time (min) | Catalyst (A) | example 4 |
| 2 | 1.0 | 93.0 |
| 5 | — | 97.5 |
| 6 | 2.2 | — |
| 8 | — | 98.4 |
| 11 | 5.3 | — |
| 15 | 10.5 | — |
| 20 | 20.1 | — |
| 26 | 35.7 | — |
| 33 | 51.9 | — |
| 40 | 66.3 | — |
| 46 | 75.6 | — |
| 52 | 82.7 | — |
| 58 | 86.7 | — |
| 63 | 91.3 | — |
| 70 | 93.9 | — |
| 76 | 95.8 | — |
| 82 | 97.5 | — |
| 90 | 98.5 | — |

1. Compounds of the formulae (I) and (II) 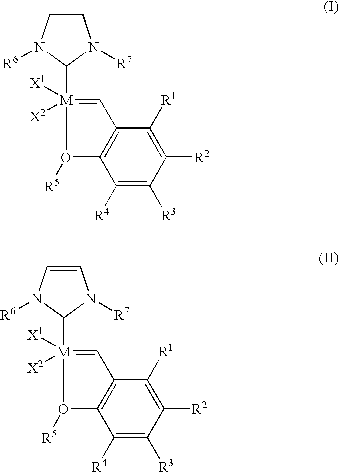
where
M is a transition metal of the 8th transition group of the Periodic Table,
X¹ and X² are the same or different and are each an anionic ligand,
R¹, R², R³ and R⁴ are the same or different and are each hydrogen, with the proviso that at least one radical R¹ to R⁴ is different to hydrogen, or are each cyclic, straight-chain or branched alkyl radicals having from 1 to 50 carbon atoms or aryl radicals having from 6 to 30 carbon atoms, where at least one hydrogen atom in the radicals mentioned is optionally replaced by an alkyl group or a functional group, and R¹ and/or R⁴ is also halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy, and/or
R¹ and R² or R² and R³ or R³ and R⁴ or R⁴ and R⁵ are part of a cyclic system which consists of a carbon framework having from 3 to 20 carbon atoms, not including the carbon atoms in formula (I) and (II), where at least one hydrogen atom is optionally replaced by an alkyl group or a functional group, and/or at least one carbon atom of the cycle is optionally being replaced by a heteroatom from the group of S, P, O and N, and
R⁵ is hydrogen or a cyclic, straight-chain or branched alkyl radical having from 1 to 20 carbon atoms or an aryl radical having from 6 to 20 carbon atoms, where at least one hydrogen atom in the radicals mentioned is optionally replaced by an alkyl group or a functional group, and
R⁶ and R⁷ are the same or different and are each cyclic, straight-chain or branched alkyl radicals having from 1 to 30 carbon atoms or are each aryl radicals having from 6 to 20 carbon atoms, where at least one hydrogen atom is optionally replaced by an alkyl group or a functional group.

2. Compounds as claimed in claim 1, characterized in that
M is ruthenium or osmium,
X¹ and X² are the same or different and are each an anionic ligand from the group of halides, pseudohalides, hydroxides, alkoxides, carboxylates and sulphonates, the pseudohalides preferably being cyanide, thiocyanate, cyanate, isocyanate and isothiocyanate,
R¹, R², R³ and R⁴ are the same or different and are each hydrogen, with the proviso that at least one radical R¹ to R⁴ is different to hydrogen, or are each cyclic, straight-chain or branched alkyl radicals having from 1 to 20 carbon atoms or aryl radicals having from 6 to 20 carbon atoms, where at least one hydrogen atom in the alkyl and aryl radicals mentioned is optionally replaced by a functional group, and R¹ and/or R⁴ is halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy, or
R¹, R² and R³ are each hydrogen and R⁴ is a cyclic, straight-chain or branched alkyl radical having from 1 to 20 carbon atoms or an aryl radical having from 6 to 20 carbon atoms, where at least one hydrogen atom in the radicals mentioned is optionally replaced by an alkyl group or a functional group, or is halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy, or
R¹ and R⁴ are the same or different and are each hydrogen or an aryl radical having from 6 to 20 carbon atoms, where at least one hydrogen atom in the aryl radical is optionally replaced by an alkyl group or a functional group, or are each halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy and R² and R³ are part of a cyclic aromatic system having from 4 to 14 carbon atoms, not including the carbon atoms in formulae (I) and (II) of claim 1, where at least one hydrogen atom is optionally replaced by an alkyl group or a functional group, or R⁵ is a straight-chain or branched alkyl radical having 1 to 20 carbon atoms, and
R⁶ and R⁷ are the same or different and are each aryl radicals having from 6 to 14 carbon atoms, where at least one hydrogen atom is optionally replaced by an alkyl group or a functional group.

3. Compounds as claimed in claim 1, characterized in that
M is ruthenium,
X¹ and X² are the same and are each an anionic ligand from the group of halides and pseudohalides, the pseudohalides preferably being cyanide, thiocyanate, cyanate and isocyanate,
R¹, R², R³ and R⁴ are the same or different and are each hydrogen, with the proviso that at least one radical R¹ to R⁴ is different to hydrogen, or are each cyclic, straight-chain or branched alkyl radicals having from 1 to 10 carbon atoms or aryl radicals having from 6 to 14 carbon atoms, where at least one hydrogen atom in the alkyl or aryl radicals mentioned is optionally replaced by an alkyl group or a functional group, and R¹ and/or R⁴ is halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy, or
R¹, R² and R³ are each hydrogen and R⁴ is an aryl radical having from 6 to 14 carbon atoms, where at least one hydrogen atom in the aryl radical is optionally replaced by an alkyl group or a functional group, or is halogen, C₁-C₄-alkoxy, C₆-C₁₀-aryloxy, cyano, C₁-C₄-alkoxy-carbonyl, C₆-C₁₀-aryloxycarbonyl or aliphatic or aromatic C₁-C₁₀-acyloxy, or
R¹ is hydrogen or halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy and R⁴ is hydrogen or an aryl radical having from 6 to 14 carbon atoms, where at least one hydrogen atom in the aryl radical is optionally replaced by an alkyl group or a functional group, or is halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy, and R² and R³ are part of a cyclic aromatic system having from 4 to 8 carbon atoms, not including the carbon atoms in formula (I) of claim 1, where at least one hydrogen atom is optionally replaced by an alkyl group or a functional group, or
R⁵ is a branched alkyl radical having from 3 to 8 carbon atoms, and
R⁶ and R⁷ are identical aryl radicals having from 6 to 10 carbon atoms, where at least one hydrogen atom is preferably replaced by an alkyl group or a functional group.

4. A process for preparing compounds of the formulae (I) and (II) as claimed in at least one of claims 1 to 3, by exchanging the phosphine ligand PZ₃ in compounds of the formula (VI) 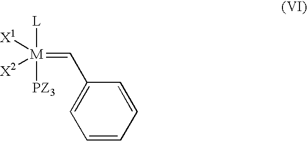
where
L is 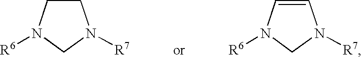
and
R⁶ and R⁷ are each as defined in claims 1 to 3 and
M, X¹ and X² are each as defined in claims 1 to 3 by ligands of the formula (VII) 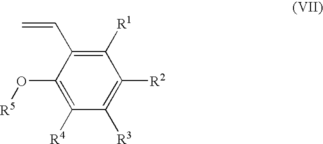
where R¹ to R⁵ are each as defined in claims 1 to 3.

5. The process as claimed in claim 4, characterized in that the reaction takes place in the presence of compounds which are capable of scavenging phosphines.

6. Compounds of the formula (VII) 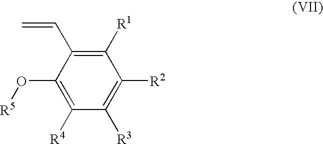
where
R¹, R², R³ and R⁴ are the same or different and are each hydrogen, with the proviso that at least one radical R¹ to R⁴ is different to hydrogen, or are each cyclic, straight-chain or branched alkyl radicals having from 1 to 50 carbon atoms or aryl radicals having from 6 to 30 carbon atoms, where at least one hydrogen atom in the radicals mentioned is optionally replaced by an alkyl group or a functional group, and R¹ and/or R⁴ is also halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy, and/or
R¹ and R² or R² and R³ or R³ and R⁴ or R⁴ and R⁵ are part of a cyclic system which consists of a carbon framework having from 3 to 20 carbon atoms, not including the carbon atoms in formula (I) and (II), where at least one hydrogen atom is optionally replaced by an alkyl group or a functional group, and/or at least one carbon atom of the cycle is optionally being replaced by a heteroatom from the group of S, P, O and N, and
R⁵ is hydrogen or a cyclic, straight-chain or branched alkyl radical having from 1 to 20 carbon atoms or an aryl radical having from 6 to 20 carbon atoms, where at least one hydrogen atom in the radicals mentioned is optionally replaced by an alkyl group or a functional group.

7. Compounds of the formula (VII) as claimed in claim 6 where
R¹, R², R³ and R⁴ are the same or different and are each hydrogen, with the proviso that at least one radical R¹ to R⁴ is different to hydrogen, or are each cyclic, straight-chain or branched alkyl radicals having from 1 to 20 carbon atoms or aryl radicals having from 6 to 20 carbon atoms, where at least one hydrogen atom in the alkyl and aryl radicals mentioned is optionally replaced by a functional group, and R¹ and/or R⁴ is halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy, or
R¹, R² and R³ are each hydrogen and R⁴ is a cyclic, straight-chain or branched alkyl radical having from 1 to 20 carbon atoms or an aryl radical having from 6 to 20 carbon atoms, where at least one hydrogen atom in the radicals mentioned is optionally replaced by an alkyl group or a functional group, or is halogen, C₁-C₄-alkoxy, C₆-C₁-aryloxy, cyano, C₁-C₄-alkoxycarbonyl, C₆-C₁₀-aryloxycarbonyl or aliphatic or aromatic C₁-C₁₀-acyloxy, or
R¹ and R⁴ are the same or different and are each hydrogen or an aryl radical having from 6 to 20 carbon atoms, where at least one hydrogen atom in the aryl radical is optionally replaced by an alkyl group or a functional group, or are each halogen, C₁-C₄-alkoxy, C₆-C₁₀-aryloxy, cyano, C₁-C₄-alkoxycarbonyl, C₆-C₁₀-aryloxycarbonyl or aliphatic or aromatic C₁-C₁₀-acyloxy and R² and R³ are part of a cyclic aromatic system having from 4 to 14 carbon atoms, not including the carbon atoms in formulae (I) and (II) of claim 1, where at least one hydrogen atom is optionally replaced by an alkyl group or a functional group, or
R⁵ is a straight-chain or branched alkyl radical having 1 to 20 carbon atoms.

8. A process for preparing compounds of the formula (VII) as claimed in claims 6 and 7, by converting compounds of the formula (XI) 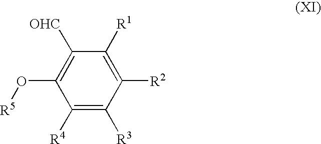
in a Wittig reaction.

8. The use of the compounds of the formula (I) and (II) as claimed in claims 1 to 3 as catalysts.

9. The use of the compounds of the formula (I) and (II) as claimed in claims 1 to 3 as catalysts in a metathesis reaction.

10. The use of the compounds of the formula (VII) as claimed in claims 6 and 7 as ligands for preparing transition metal complexes.
